(19) United States
(12) Patent Application Publication
(10) Pub. No.: US 2019/0023593 A1
(43) Pub. Date: Jan. 24, 2019

(54) WASTEWATER TREATMENT PROCESS AND PLANT

(71) Applicant: SUEZ INTERNATIONAL, Paris la Défense Cedex (FR)

(72) Inventors: Adriana GONZALEZ OSPINA, LE PECQ (FR); Bruno DOMENJOUD, PUTEAUX (FR)

(21) Appl. No.: 16/071,698

(22) PCT Filed: Jan. 23, 2017
(86) PCT No.: PCT/EP2017/051314

§ 371 Date: Jul. 20, 2018

(30) Foreign Application Priority Data
Jan. 21, 2016 (FR) 1650489

(51) Int. Cl. C02F 1/78; C02F 3/12; C02F 11/06; C02F 3/08

(52) U.S. Cl. CPC C02F 1/78; C02F 3/1221; C02F 9/00; C02F 3/085; C02F 11/06

(57) ABSTRACT

Disclosed is a wastewater treatment process including at least one step of biological oxidation in a biological treatment unit, wherein ozone and an adsorbent compound are introduced, the ozonation and the adsorption each at least being induced upstream of the biological treatment unit, or else in the biological treatment unit, or else downstream of the biological treatment unit, knowing that downstream of the biological treatment unit at most either the introduction of ozone, or the introduction of the adsorbent compound is carried out. Also disclosed is a plant for implementing the process.

The invention relates to the field of the treatment of superficial, subterranean, waste or industrial water containing micropollutants.

One object of the invention is more particularly a process and a facility for treating the abovementioned water by removing conservative micropollutants compounds such as residues of natural or synthetic chemical substances, pesticides, metals, volatile organic compounds (VOC), hormones, drug residues.

Preservation requirements of water resources have led to deploy exhibit wastewater treatment systems based on global parameters. Today, the European Union has the ambition to regain the good quality for aquatic environments. Directive 2000/60/EC of the European Parliament and of the Council of 23 Oct. 2000, establishing a framework for community action in the field of water policy, called the Water Framework Directive (WFD), has the ambition progressively to reduce in the long term wastewater contaminant discharges in aquatic receiving environments. Sewage sludge is also produced during the treatment of wastewater. As regards them, Council directive 91/271/EEC of 21 May 1991, concerning urban wastewater treatment, aims at promoting recovery of sludge as soon as possible. The objective of good chemical and ecological status for all the European bodies of water involves the adoption of measures aiming at controlling discharges, emissions and losses for chemicals identified at the European level as priority substances and priority hazardous substances and established at the local/river basin/national level for relevant substances determined based on inventories.

Treatment plants make up the main point of collection and subsequently of discharge of micropollutants into the environment. These micropollutants belong to different categories which reflect all the water uses and their diffusion into the environment: domestic and industrial chemicals and their by-products, pesticides, pharmaceutical products and personal care products. The published results about various national inventories indicate that usual design and operation of biological sewage plants allow a limited reduction in the global micropollutant load.

Several research and operational test projects have compared the performance of the processes for the treatment of micropollutants in a tertiary mode, that is downstream of the biological oxidation treatment.

Thus, the French operational research program ARMISTIQ has quantised the treatment performance of an array of micropollutants by oxidation and adsorption on activated carbon.

Margot et al., 2013, summarises Suiss results from comparative tests made in the Vidy purification plant in Lausanne with ozone and powdered activated carbon followed by ultra-filtration. Both conclude to high treatment capabilities of ozone and activated carbon although they do not exactly act on the same micropollutants. Ozone is more specific, the adsorption can imply a wider spectrum of compounds but with a lower performance level.

Margot J. et al. “Treatment of micropollutants in municipal wastewater: ozone or powdered activated carbon?”, Science of the Total Environment, 461-462 480-498 2013.

The tertiary micropollutant treatment is thus technically and economically viable and can occur by using both existing technologies of activated carbon adsorption and ozonation. The performance can be equivalent and high with the proviso to match the ozone and the activated carbon treatment rate, renewed dose of powdered activated carbon or CAG volume and regeneration frequency, the type of micropollutants to be treated and the ultimate treatment performance objective to be reached.

According to other approaches further centred on the implementation of adsorption reactions, processes based on the activated carbon adsorption have been developed to remove micropollutants, initially for drinking water production and then for clarified wastewater treatment. The processes used to date for adsorption implement grain, powdered, or micro-grain activated carbons with contact reactors including or not a clarification step in the same structure. A contact time between water and carbon is necessary in order to ensure an efficient adsorption. This generates a minimum covered area which can be more or less significant depending on whether or not the reactor has the possibility to clarify water to separate activated carbon from the treated water.

By way of example, patent application FR 2874 913 describes a reactor implementing micro-grain activated carbon for the treatment of organic micropollutants contained in the subterranean or surface water having a low organic pollution. The treatment, for making water drinkable, occurs in an up-flow reactor containing a moving bed of expanded activated carbon. Within the same reactor, separation of the treated water from the carbon suspension is made by gravity. This process provides in situ renewing or regeneration of the micro-grain carbon bed by extracting part of the carbon mass and injecting new micro-grain activated carbon. Part of the carbon extracted can also be reinjected into the reactor after it has been regenerated.

Reactors described in patent application FR 2946 333 implement coagulated and flocculated powdered activated carbon for the treatment of more loaded water than those previously mentioned. The treatment occurs in a single up-flow reactor.

Patent application FR 2973 794 describes a clarification treatment process comprising an adsorption of a clarified water portion and a clarification of a mixture of clarified water and water to be treated. The process associates coagulation, flocculation and ballasted settling of the water to be treated in order to ensure low concentrations of organic carbon dissolved in the water treated.

According to other approaches further centred on the implementation of ozone oxidation, processes implement facilities comprising producing ozone and contacting the ozone produced with the clarified secondary water to be treated in a specific structure. These reactors are mainly of the compartmentalized contact column type with a high water height to favour ozone transfer. The latter is injected at the bottom of the column using diffusers to produce fine bubbles. To ensure an efficient oxidation and the best ozone transfer rate, it is necessary to carry out the contact between water and ozone for a sufficiently long time which implies reactors of some size.

For the sake of optimising and enlarging the treatment field, other solutions, such as that described in patent application U.S. Ser. No. 00/557,8205A, have been developed by associating several oxidising agents in an advance oxidation POA. The document describes a facility for partially removing micropollutants from bore-hole water by combining the action of ozone and hydrogen peroxide. More particularly, the facility is for treating pesticide or biocide type molecular ozone refractory compounds, through the generation of a more powerful but not selective oxidant which is the hydroxyl radical in a simplified injector/mixer/contactor contact reactor.

Other pathways have been explored such as those which consist in integrating several treatment mechanisms. For example, the addition of activated carbon in a secondary biological treatment for the purification of urban water as made during operational works in the Locle plant, micropollutant treatment by powdered activated carbon dosage in the activated sludge of a MBR (Rapport final sur les essais pilotes à la STEP du Locle, Déc 2014).

By way of example, patent WO 20017053110A1 provides a two-step treatment associating a wastewater pretreatment by ozonation in a reactor in which water is maintained in contact with ozone during a period of time between 1 and 6 hours followed by a biological treatment for the treatment of industrial water.

However, these developed solutions have drawbacks mainly related to the affinity specificity between the mechanisms implemented and the physico-chemical characteristics of the micropollutants.

Thus, as for the tertiary ozonation, contacting the gas phase (ozone) and the liquid phase (effluent to be treated) causes the presence of a contact structure (or contactor). The contactor has a high covered area which is a drawback in particular in urban zones or on already existing purification plants.

In addition, the presence of potentially toxic oxidation by-products in treated water which result from the ozone action can be undesirable depending on the disposal point (sensitive natural medium) or the subsequent use. The formation of undesirable toxic by-products appears to be related to the ozone dose in particular in the case of the formation of bromates. The latter are significantly formed when the water to be treated contains bromides and that the ozone dose exceeds the immediate ozone demand of the water to be treated (immediate ozone demand: ozone dose transferred from which dissolved ozone appears). Thus, there is a non negligible risk of forming potentially toxic by-products.

Finally, the removal of organic micropollutants is directly related to the ozone dose transferred as well as to the reactivity of the substances. Ozone selectively oxidises organic micropollutants. Its low-dose application will thus have a positive effect only almost exclusively on reactive compounds and not on other ones.

The use of ozone in an industrial wastewater pretreatment has the drawback to have a high covered area (succession of treatments with an ozonation step requiring a high contact time in view of the ozone doses which are necessary for this type of application).

Now, as regards the use of the tertiary activated carbon (that is downstream of the biological treatment), it turns out that contacting the activated carbon and water to be treated requires a contact structure and a separation structure optionally (in the case of the use of powdered activated carbon). Hence, the covered area is made too high.

On the other hand, the activated carbon selectively adsorbs organic compounds only retaining “adsorbable” compounds. Carbon doses should be strongly increased for the poorly adsorbable compounds to be significantly retained.

As regards now the use of powdered activated carbon in biology, the process consisting in applying in tertiary powdered activated carbon can also involve recirculating powdered activated carbon in the secondary biological treatment system. This improved alternative of the tertiary powdered activated carbon, although it is beneficial from the performance point of view, still involves one or more structures downstream of the biological treatment process. This downstream treatment remains at an identical powdered activated carbon injection dose. The drawbacks thus remain the covered area and the non-optimisation of powdered activated carbon doses used in tertiary.

Thus, the purpose of the invention is to remove all or part of the abovementioned drawbacks. The object of this invention is thus to enlarge the range of micropollutants treatable by a single system with an optimisation of treatment doses. It relies on associating activated carbon adsorption with ozonation in a biological purification process.

More particularly, one object of the invention is a wastewater treatment process comprising at least one biological oxidation step in a biological treatment unit, characterised in that ozone (O3) and an adsorbent compound are introduced, said ozonation and said adsorption being each induced at least, upstream of the biological treatment unit, or in the biological treatment unit, or downstream of the biological treatment unit, given that downstream of the biological treatment unit, at most either the ozone introduction, or the adsorbent compound introduction is performed.

The ozone introduction induces an ozonation. The adsorbent introduction induces an adsorption. Both reactions, coupled with the biological oxidation or bio-assimilation in the biological reactor, enable the treatment of a wide spectrum of micropollutants to be ensured.

Optional complementary or substitute characteristics of the invention are set forth hereinafter.

Downstream of the biological treatment unit, no ozone introduction or adsorbent compound introduction can be performed, such that the ozone and the adsorbent compound are each respectively introduced either upstream of the biological treatment unit, or in the biological treatment unit.

The adsorbent compound introduction can be performed downstream of the ozone introduction.

The adsorbent compound can include grain or micro-grain powdered activated carbon (PAC).

The adsorbent compound can include ion exchange resins or zeolites.

Ozone can be introduced in proportions ranging from 0 to 25 mg/L, preferably between 1.5 and 15 mg/L.

The adsorbent compound can be introduced in proportions ranging from 0 to 30 mg/L, preferably between 5 and 20 mg/L.

The biological treatment unit can include a conventional activated sludge reactor or a fluidised moving bed reactor or a fixed bed reactor or a sequential biological reactor or a membrane bioreactor.

The biological treatment unit can include a biological reactor in which the ozone and/or adsorbent compound introduction is carried out.

The biological treatment unit can comprise a settler or float type separator downstream of the biological reactor, the ozone and/or adsorbent compound introduction being then possibly carried out in the separator.

The biological treatment unit can comprise a settler or float type separator, downstream of the biological reactor and a circuit for recirculating a fraction of the sludge from the settling step to the biological reactor, then possibly the ozone and/or adsorbent compound introduction being carried out in the recirculation circuit or in the separator, or in both.

Another object of the invention is a wastewater treatment facility comprising:
a biological treatment unit provided with at least one biological reactor arranged to carry out at least one biological oxidation step,
a wastewater inlet circuit feeding the biological treatment unit with wastewater,
a circuit for discharging wastewater off said biological treatment unit,
characterised in that it further comprises at least a first and a second device to introduce ozone and an adsorbent compound respectively, in the inlet circuit or in the discharge circuit, or in the biological treatment unit, the discharge circuit being at most in fluid communication with either of the first or second introduction device.

Optional complementary or substitute characteristics of the invention are set forth hereinafter.

The first and the second introduction device can be arranged to introduce ozone and an adsorbent compound respectively, in the feeding circuit or in the biological treatment unit.

The first ozone introduction device can be arranged upstream of the second adsorbent introduction device.

The biological treatment unit can further comprise a separator downstream of the biological reactor, the separator possibly being of the settler or float type, and at least either of the first or second introduction device being in communication with the separator.

The biological treatment unit can further comprise a separator and a circuit for recirculating a fraction of the sludge from the separator to the biological reactor, at least either of the first or the second introduction device being in communication with the recirculation circuit.

The wastewater treatment facility can comprise downstream of the biological treatment unit, as a first or second introduction device, a contactor arranged to contact water at the outlet of said treatment unit with either the ozone, or the adsorbent compound.

The biological reactor can be a conventional activated sludge reactor or a fluidised moving bed reactor or a fixed bed reactor or a sequential biological reactor or a membrane bioreactor.

Either or both of the first or second ozone or adsorbent introduction device can be in communication with the biological reactor.

Further advantages and features of the invention will appear upon reading the detailed description of implementations and embodiments in no way limiting, and the following appended drawings:

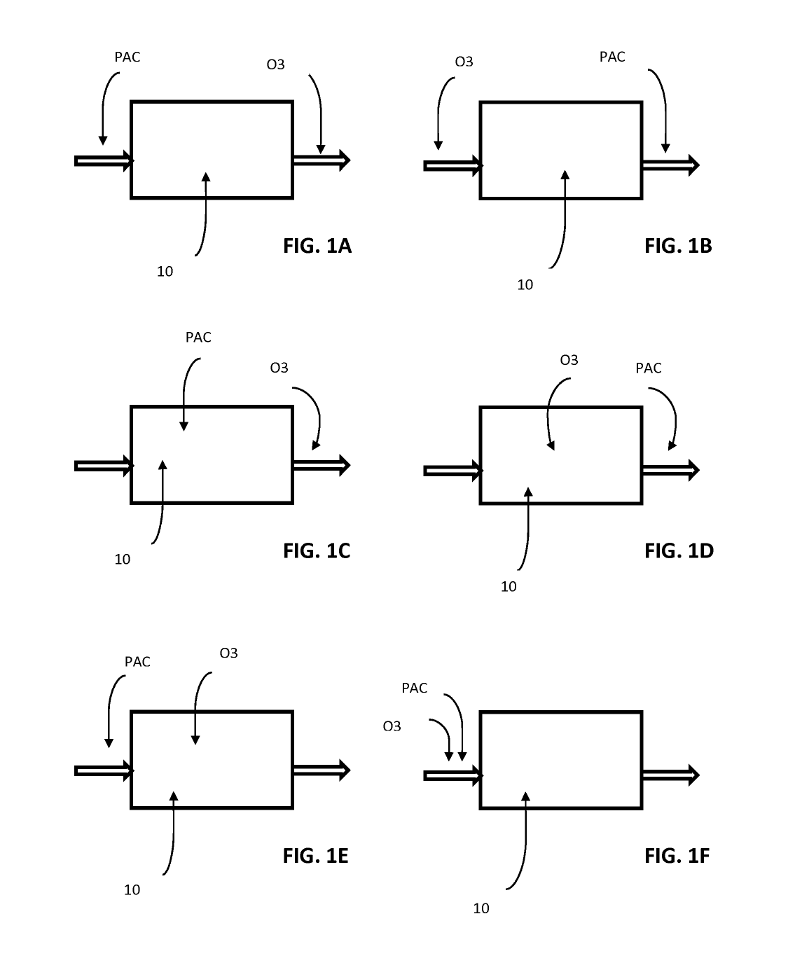

FIGS. 1A to 1H each correspond to a schematic representation of various embodiments of the invention,

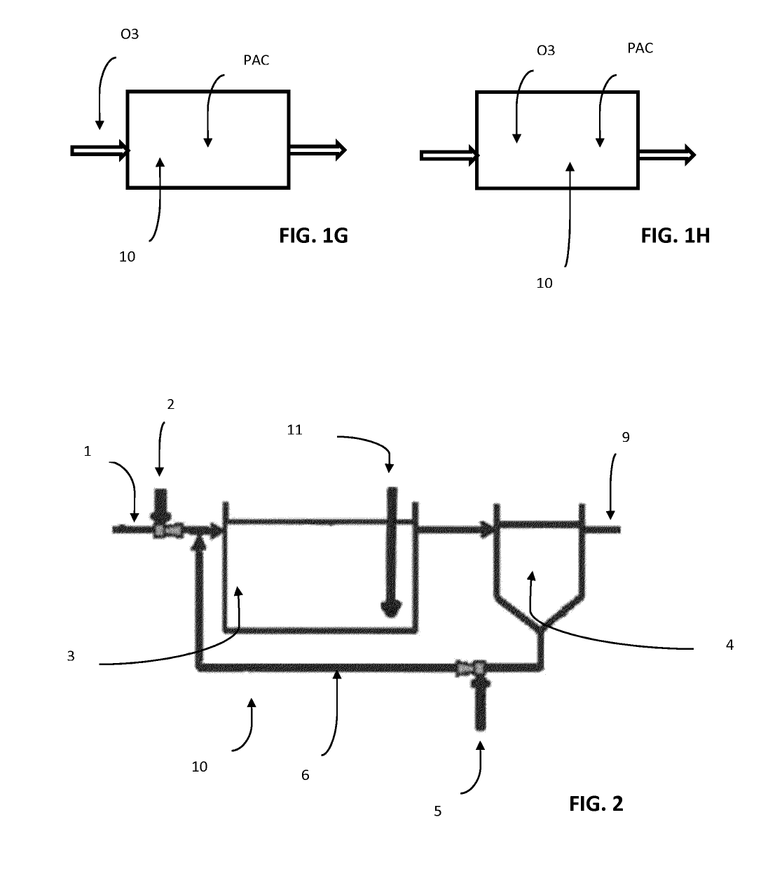

FIG. 2 corresponds to a schematic representation of a biological treatment unit according to one embodiment of the invention.

The wastewater treatment process, according to the invention comprises at least one biological oxidation step in an activated sludge biological treatment unit 10. By “biological oxidation step”, it is meant a wastewater treatment step in which aerobic micro-organisms oxidise pollutant compounds in the presence of oxygen, so as to degrade them. This can be an aerobic treatment requiring an oxygen supply either anoxic or anaerobic, in which case the micro-organisms draw the energy in their reserves for their activity and reproduction.

According to the process, ozone and an adsorbent compound are introduced into the biological treatment unit 10 provided with a biological reactor 3, or upstream of the biological treatment unit 10, or downstream of the biological treatment unit 10, given that downstream of the biological treatment unit 10, at most either the ozone introduction, or the adsorbent compound introduction is performed. In this way, the biological oxidation step conducted by microorganisms is enhanced by an ozonation step and an adsorption step, the abovementioned steps being concomitant or successive. By “upstream of the biological treatment unit”, it is meant that the ozone and/or the adsorbent compound are introduced upstream of the biological reactor 3, that is for example in the circuit which feeds water to be treated into the reactor.

By “downstream of the biological treatment unit”, it is meant that the ozone and/or the adsorbent compound are introduced beyond the outlet of the treatment unit, that is at least in the discharge circuit or after.

By “ozonation”, it is meant an oxidation chemical treatment, either directly, with the (very selective) molecule O3, or indirectly, because of the action of secondary species such as the free radicals OH— formed by ozone decomposition in contact with water.

By “adsorption”, it is meant the removal of compounds (mainly organic matter and micropollutants) which is carried out by virtue of the surface phenomenon by which molecules are bound to porous sites of the activated carbon through different forces (electric charges, dipole-dipole interaction, Van der Waals forces) or (hydrogen, covalent, etc.) bonds. Adsorption can be either physical (non specific) and mainly depend on the size of the porous site, or chemical (specific) due to the presence of charged sites on the surface of the activated carbon.

The different possible configurations are detailed in FIGS. 1A to 1H, with more precisely:
in FIG. 1A, the adsorbent compound introduction upstream of the biological treatment unit 10, and the ozone introduction downstream of the biological treatment unit 10. In this way, adsorption synergistically acts with the bio-transformation within the biological reactor of the biological treatment unit 10.
In FIG. 1B, the adsorbent compound introduction downstream of the biological treatment unit 10, and the ozone introduction upstream of the biological treatment unit 10. In this way, ozonation synergistically acts with the bio-transformation within the biological reactor.
In FIG. 1C, the adsorbent compound introduction into the biological treatment unit 10, and the ozone introduction downstream of the biological treatment unit 10. In this way, adsorption synergistically acts with the bio-transformation within the biological reactor.
In FIG. 1D, the adsorbent compound introduction downstream of the biological treatment unit 10, and the ozone introduction into the biological treatment unit 10. In this way, ozonation synergistically acts with the bio-transformation within the biological reactor.
In FIG. 1E, the adsorbent compound introduction upstream of the biological treatment unit 10, and the ozone introduction into the biological treatment unit 10. In this way, ozonation and adsorption synergistically act with the bio-transformation within the biological reactor.
In FIG. 1F, the adsorbent compound and ozone introduction upstream of the biological treatment unit 10. In this way, ozonation and adsorption synergistically act with the bio-transformation within the biological reactor.
In FIG. 1G, the adsorbent compound introduction into the biological treatment unit 10, and the ozone introduction upstream of the biological treatment unit 10. In this way, ozonation and adsorption synergistically act with the bio-transformation within the biological reactor.
In FIG. 1H, the adsorbent compound and ozone introduction into the biological treatment unit 10. In this way, ozonation and adsorption synergistically act with the bio-transformation within the biological reactor.

According to preferential embodiments corresponding to those described in FIGS. 1E, 1F, 1G, 1H, no ozone or adsorbent compound introduction is performed downstream of the biological treatment unit 10, such that the ozone and adsorbent compound are each respectively introduced either upstream of the biological treatment unit 10, or into the biological treatment unit 10. These configurations have the advantage in terms of process, of facilitating oxidation conducted by the microorganisms since micropollutant degradation and trapping by the ozone and the adsorbent compound happen before or during biological oxidation. In other words, ozonation and adsorption treatment do not preferably follow the biological oxidation step, but rather synergistically participate in the biological oxidation step, thus optimising the efficiency of the treatment unit 10.

Advantageously, the adsorbent compound introduction is carried out downstream of the ozone introduction. In this way, the adsorbent compound traps further ozone and/or bio-transformation refractory organic compounds, insofar as the ozonation step has already degraded a number of organic compounds.

The adsorbent can be chosen from any type of adsorbent known to those skilled in the art such as activated carbon (irrespective of its particle size) or resin. The adsorbent compound can also include ion exchange resins or zeolites. Preferably, the adsorbent is powdered activated carbon. The implementation of such an adsorbent enables activated carbon to be optimally used or reused, since powdered activated carbon is a relatively expensive material. The amount and nature of the activated carbon powder will be adjusted as a function of the quality of water to be treated. The performance of the activated carbon powder is highly conditioned by physico-chemical characteristics inherent to micropollutants and to organic matter to be treated (amount, size, molecular weight, hydrophobicity, charge, etc.), the characteristics of the material used (for an activated carbon: activation degree, porosity and pore size distribution, specific area, charge, structure, carbon raw material, etc.), and the characteristics of the facility operating parameters (flow rate, use of coagulants and flocculants, pH, hydraulic contact time/flow velocity, residence time in the reactor, etc.).

Preferentially, ozone is introduced in proportions ranging from 0 to 25 mg/L, preferably between 3 and 15 mg/L, this amount being expressed as a function of the ozone point of introduction. Thus, downstream of the biological treatment, the range between 0 and 15 mgO3/L raw water can be favoured, in recirculated sludge, the range between 0.2 and 1.6 mgO3/g recirculated sludge, and downstream of the biological treatment between 1.5 and 5 mgO3/L water. In this way, the advantage of selectively acting on each contact point between ozone and the matter to be treated is achieved while using the strictly necessary dose.

Also preferentially, the adsorbent compound is introduced in proportions ranging from 0 to 30 mg/L raw water, and preferably between 5 and 20 mg/L. In this manner, the adsorption areas to which the micropollutants can bind by the physico-chemical bonds peculiar to this phenomenon can be significantly enlarged. This generates an increase in the adsorption performance in comparison with the biological treatment alone.

The synergy between the ozone and adsorbent compound introduced is all the sharper in the preferential ranges previously mentioned, since proportions ranging from 0 to 25 mg/L, preferably between 3 and 15 mg/L for ozone and ranging from 0 to 30 mg/L, and preferably between 5 and 20 mg/L, for the adsorbent compound, enable a very good weakening in removing the main compounds to be achieved.

As regards the wastewater treatment facility, the invention provides, as represented in FIG. 2, a biological treatment unit 10 provided with at least one biological reactor 3 arranged to carry out at least one activated sludge biological oxidation step, for example. This biological treatment unit is fed by a wastewater inlet circuit 1 feeding the biological reactor 3 with wastewater. The treated water exits the biological treatment unit via a circuit 9 for discharging wastewater off said biological treatment unit. According to the invention, the facility further comprises at least a first and a second device to introduce ozone and an adsorbent compound respectively, in the inlet circuit 1, as represented with reference 2 in FIG. 2 or in the discharge circuit 9, or in the biological treatment unit 10 with reference 11 which introduces ozone and/or the adsorbent compound into the reactor 3. The first and the second device for introducing ozone and an adsorbent compound respectively, can for example be an injector or a static mixer set in the inlet circuit 1 without a specific contactor being necessary. On the other hand, in the case where the ozone or adsorbent compound introduction device occurs in the discharge circuit 9, it can maintain thereby the form of an injector/mixer or assume that of a specific contactor.

All the possible configurations are described in FIGS. 1A to 1H which were previously detailed.

By “biological treatment unit”, it is meant an entity comprising at least one biological reactor provided with intake means 1 and discharge means 9. The biological reactor 3 can be for example a conventional activated sludge reactor or a fluidised moving bed reactor or a fixed bed reactor or a sequential biological reactor or a membrane bioreactor.

By “conventional activated sludge reactor”, it is meant an aeration tank generally followed by a clarifier, the wastewater purification being thus made according to a succession of tanks disposed behind each other.

By “fluidised movable bed reactor”, it is meant an aeration tank (or sequential aeration tank) in which supporting materials maintained in fluidisation by the air supply of the process are submerged and which enables the amount purifying biomass to be increased, the one which is developed on the surfaces of submerged materials. In this way, the advantage of increasing the treatment ability in comparison with a conventional activated sludge biological reactor is achieved by providing for the same load to be treated, a lower reactor volume.

By “fixed bed reactor”, it is meant filters packed with mineral materials through which the water to be purified passes. In this way, the advantage of filtering purified water at the same time in a single treatment step is achieved.

By “sequential biological reactor”, it is meant a free culture treatment device in which the treatment steps are separated in time and not in space. Alternatively, the supply of water to be treated and then the reaction phases followed by water clarification by static settling and the purge of the treated water are made. In this way, the advantage of having a great compactness in the treatment structures is achieved.

By “membrane bioreactor”, it is meant the activated sludge biological treatment coupled with water clarification by ultra or microfiltration membranes. In this way, a high quality clarified water and the advantages induced by disinfection provided by the membrane are achieved.

Conventional activated sludge reactors, fixed bed reactors or a sequential biological reactor have the advantage of being widespread facilities having a simple operation. Thus, the invention can be implemented with little modification and relies on classical structures having a simple operation. The synergic ozone and adsorbent injection about or within the biological reactor enables the use of a specific contactor to be dispensed with and thus enables the covered area of this type of facility to be reduced.

Fluidised moving bed reactors and membrane bioreactors are more recent and have good efficiencies. However, fluidised moving bed reactors require a significant energy supply which is no longer justified within the scope of the invention in view of the synergy related to the activated carbon and ozone introduction. Concerning membrane reactors, in the long term, the use of activated carbon could bring about a membrane abrasion phenomenon. Thus, the membrane skin could be damaged by the use of activated carbon and decrease the reactor efficiency and/or be detrimental to the positive effect of the use of activated carbon.

Still according to the invention, the discharge circuit 9 is at most in communication with either of the first or the second introduction device. In other words, it is not contemplated to introduce both ozone and activated carbon in the discharge circuit 9.

According to one alternative, the biological treatment unit 10 can further comprise a settler or float type separator 4 downstream of the biological reactor 3 and a circuit 6 for recirculating a fraction of the sludge from the settling step to the biological reactor 3. Wastewater exiting the biological reactor 3 are then conveyed to the separator 4, also called a clarifier or secondary settling tank or clarifier, or even a float type separator, mounted downstream of the biological reactor 3. The separator 4 is arranged to perform a settling step in which biological flocs are typically separated from wastewater, these biological flocs being made during the at least one biological treatment step, within the biological reactor 3.

This alternative offers the possibility to carry out the ozone and/or activated carbon injection by means of either of the first or second introduction device, directly in the recirculation circuit 6. This is represented in FIG. 2 with reference 5.

This alternative also offers the possibility to carry out ozone and/or activated carbon injection directly into the separator. Thus, in the case where the separator is a float ozone or activated carbon can be directly injected into this float (not represented in FIG. 2).

This is particularly interesting behind a fluidised moving bed bioreactor type reactor (MBBR) which needs to separate the water treated from the biomass and enables the global compactness of the facility to be improved. Indeed, the float is compact much like the moving bed bioreactor. Further, direct injection into the float enables the contactor to be dispensed with.

Of course, the ozone and/or adsorbent compound injection can also be directly made into the biological reactor 3, as represented with reference 11. This mode has the advantage of not requiring the use of a contactor and thus of providing a compact solution, of maximising the treatment performance of the biological reactor with respect to a biological treatment alone (indeed, by virtue of the adsorbent, compounds that the biology alone of the biological reactor could not have metabolised can be acted on) and of removing a higher spectrum of organic and inorganic compounds.

In a preferential embodiment, the activated carbon (or any other adsorbent) introduction into the biological reactor and the ozone introduction upstream of the biological reactor will be favoured.

Another preferential embodiment could in particular provide activated carbon injection into the fluidised moving bed bioreactor and provide ozone injection into the float. The activated carbon enables the biological treatment performance to be increased by increasing the available area for adsorption. Then, ozone has the function to treat soluble compounds present at the float which have not been adsorbed. There remains just to separate water from sludge, and then sludge from the activated carbon.

According to another preferential mode of the invention, the first and the second introduction device are arranged to introduce ozone and an adsorbent compound respectively, into the inlet circuit 1 or into the biological treatment unit 10. In this way, it is not contemplated to introduce ozone or the adsorbent compound into the discharge circuit 9. This configuration makes it possible to avoid resorting to a specific contactor, which is made mandatory if the ozone or activated carbon introduction occurs downstream of the unit 10, that is in the discharge circuit 9. Hence, the configurations represented in FIGS. 1E, 1F, 1G, 1H have the advantage of being less restrictive in terms of structure.

Also advantageously, the first ozone introduction device is arranged upstream of the second adsorbent introduction device. Thus, the adsorbent compound traps further oxidation or bio-transformation refractory organic compounds, insofar as the ozonation step has already degraded a number of organic compounds.

By way of example, Table 1 summarises, for a number of compounds, their chemical characteristics and in particular the constant KO3 to be related to the affinity to the molecular ozone, the coefficient Log Kow to be related to activated carbon adsorbability and finally, biodegradability.

Among the compounds selected, ibuprofen is the only one which is properly degraded by a biological system but poorly adsorbable and oxidable. Atrazine and diuron are poorly biodegradable and oxidable but properly adsorbed on activated carbon. Finally, sulphamethoxazole is very reactive to ozone but poorly adsorbable and poorly biodegradable.

TABLE 1
Physico-chemical characteristics of indicator compounds.

| | | | Log | kO3 | Biodegrad- | Absorb- | Ozone |
|---|---|---|---|---|---|---|---|
| Name | Family | Class | Kow | (M¹ · s⁻¹) | ability | ability | reactivity |
| Atrazine | Pesticide | Triazine | 2.2 | 6 | low | high | low |
| Diuron | Pesticide | Substituted | 2.8 | 14.7 | low | high | low |
| | | urea | | | | | |
| Ibuprofen | Pharma- | Analgesic | 3.8 | 9.6 | high | low | low |
| | ceutical | | | | | | |
| Sulpha- | Pharma- | Antibiotic | 0.89 | 2.5 10⁶ | low | low | high |
| methoxazole | ceutical | | | | | | |

Table 2 gathers the removal efficiencies obtained for atrazine, diuron, ibuprofen and sulphamethoxazole for the biological treatment (biology), the integrated treatment combining ozonation on the biological treatment feed followed by the biological treatment (O3 plus biology), the tertiary ozonation treatment (tertiary O3), the powdered activated carbon integrated treatment in the biological treatment plus the biological treatment (PAC plus biology) and finally, the tertiary powdered activated carbon treatment (tertiary PAC). The last column concerns the proposal of the present invention and the colour indicates meant the capability of a treatment combining biology, activated carbon and ozone to remove each of these compounds.

In the case of ibuprofen, the biological treatment alone enables removal efficiencies higher than 90% to be obtained. The addition of a tertiary ozone treatment or a tertiary powdered activated carbon would partially improve its removal but they are not necessary since it is already very well removed by the biological treatment.

On the other hand, atrazine and diuron are poorly removed by the biological treatment alone, respectively and 12%. Adding ozone, whether in the biological system feed or in tertiary does not enable efficiencies higher than 50% at low treatment rates to be achieved. These results are in accordance with the low biodegradability and the low reactivity to ozone of these compounds. Yet, when powdered activated carbon is added in tertiary, the removal efficiencies are much higher, 60 and 87% for atrazine and diuron respectively, to be added to the removals obtained by the biological system. In the case of these compounds, adding powdered activated carbon enables very good removal efficiencies to be achieved whereas the biological system as well as adding ozone are not efficient.

Finally, sulphamethoxazole is moderately removed by the biological treatment (65%) and with a lot of variability, adding 20 mg/L of powdered activated carbon in the biology only improves very poorly this efficiency to reach 71% and adding tertiary powdered activated carbon of 10 mg/L of powdered activated carbon causes a poor weakening of 44%. Only ozone, whether upstream of the biological system at 3 mg/L or in tertiary at 4.5 mg/L, is capable of removing significantly this compound, respectively 99 and 91%. For this substance, neither the biological treatment, nor adding powdered activated carbon enables it to be efficiently removed unlike adding ozone.

It is shown through this example that the association of only two removal mechanisms is not sufficient to cover all the organic micropollutants. Yet, it appears that the combination of the three mechanisms, in particular biodegradation, oxidation and adsorption, is efficient to cover the proper removal of all these compounds, using very low reagent doses.

TABLE 2
Example of removal efficiencies for each compound by the biological,
powdered activated carbon and ozone integrated treatments and
powdered activated carbon and tertiary ozone treatments.

| | | | | | | Biology, |
|---|---|---|---|---|---|---|
| | | | | | | ozone and |
| | | | | | | activated |
| | | O3 plus | Tertiary | PAC plus | Tertiary | carbon |
| | | biology | ozonation | biology | PAC | combination |
| Compound | Biology | 3 mgO3/L | 4.5 mgO3/L | 20 mgPAC/L | 10 mgPAC/L | (*) |
| Atrazine | 25% | 43% | 20% | 40% | 60% | >77% |
| Diuron | 12% | 5% | 25% | 40% | 87% | >90% |
| Ibuprofen | >90% | >97% | 70% | >97% | 32% | >99% |
| Sulpha- | 65% | 99% | 91% | 71% | 44% | >99% |
| methoxazole | | | | | | |

(*) with 3 mgO3/L downstream of the biological treatment and 5 mgPAC/L and 1.3 mgO3/g in recirculated sludge in the biological treatment.

In summary, the simultaneous application of ozone and powdered activated carbon around and/or in the secondary biological system makes it possible to cover a widest range of micropollutants, that is both those which are ozone reactive and those which are activated carbon adsorbable.

In addition, the invention enables very good results to be achieved as regards micropollutant treatment. When prior art only involves either of the reagents, ozone or activated carbon, the doses of said reagents to be applied to remove compounds which are less or not oxidable or adsorbable, respectively, should be highly increased. On the contrary, the simultaneous application of both reagents makes it possible to remove little or no oxidable substances via adsorption and reversely little or no adsorbable compounds via oxidation. The reagent doses involved in the innovation can thus be optimised depending on the compounds to be treated.

The reduction in ozone and activated carbon doses in the case of a simultaneous application with respect to the application of only one of both reagents also has advantages as regards sludge production for activated carbon and the formation of potential by-products for ozone when the latter is applied in tertiary. The use of a lower activated carbon dose causes a reduction in the activated carbon used as sludge to be extracted from the system and to be subsequently treated. In the case of tertiary ozonation, the reduction in the ozone dose at doses lower than the immediate ozone demand limits the formation of toxic by-products, in particular bromates. In addition, if this formation of by-products would occur, the simultaneous system has the advantage of having the biological oxidation within the treatment to be able to metabolise/neutralise them.

Ozone injection and activated carbon addition upstream or in the biology enable contact and separation specific structures (in the case of powdered activated carbon) to be dispensed with. Construction costs and covered areas are thus strongly decreased and the global system performance increased.

The above described embodiments are in no way limiting, alternatives of the invention could in particular be considered only comprising a selection of described characteristics, isolated from the other described characteristics (even if this selection is isolated within a sentence comprising these other characteristics), if this selection of characteristics is sufficient to provide a technical advantage or to differentiate the invention with respect to the state of the art. This selection comprises at least one, preferentially functional without structural detail, characteristic, or with only part of the structural details if this part only is sufficient to provide a technical advantage or to differentiate the invention with respect to the state of the art.

Of course, the invention is not limited to the examples just described and many modifications could be provided to these examples without departing from the scope of the invention. In addition, the different characteristics, forms, alternatives and embodiments of the invention could be associated with each other according to various combinations insofar as they are not incompatible or exclusive to each other.

1. A wastewater treatment process comprising at least one biological oxidation step in a biological treatment unit (10), wherein ozone (O3) and an adsorbent compound (PAC) are introduced, said ozonation and said adsorption being each induced at least, upstream of the biological treatment unit (10), or in the biological treatment unit (10), or downstream of the biological treatment unit (10), given that downstream of the biological treatment unit (10), at most either the ozone introduction, or the adsorbent compound introduction is performed.

2. The wastewater treatment process according to claim 1, wherein downstream of the biological treatment unit (10), no ozone or adsorbent compound introduction is performed, such that the ozone and the adsorbent compound are each respectively introduced either upstream of the biological treatment unit (10), or in the biological treatment unit (10).

3. The wastewater treatment process according to claim 1, wherein the adsorbent compound introduction is carried out downstream of the ozone introduction.

4. The wastewater treatment process according to claim 1, wherein the adsorbent compound includes grain or micro grain powdered activated carbon.

5. The wastewater treatment process according to claim 1, the ozone is introduced in proportions ranging from 0 to 25 mg/L.

6. The wastewater treatment process according to claim 1, wherein the adsorbent compound is introduced in proportions ranging from 0 to 30 mg/L, preferably between 5 and 20 mg/L.

7. The wastewater treatment process according to claim 1, wherein the biological oxidation step is carried out in a biological treatment unit (10) comprising a conventional activated sludge biological reactor (3) or a fixed bed reactor or a sequential biological reactor.

8. The wastewater treatment process according to claim 1, wherein the biological oxidation step is carried out in a biological treatment unit (10) comprising a fluidised movable bed reactor or a membrane bioreactor.

9. The wastewater treatment process according to claim 1, wherein the biological treatment unit (10) comprises a settler or float type separator (4) downstream of the biological reactor (3), the ozone and/or adsorbent compound introduction being carried out in the separator.

10. The wastewater treatment process according to claim 1, wherein the biological treatment unit (10) comprises a settler or float type separator (4), downstream of the biological reactor (3) and a circuit (6) for recirculating a fraction of the sludge from the settling step to the biological reactor (3), the ozone and/or adsorbent compound introduction being carried out in the recirculation circuit (6) or in the separator, or in both.

11. The wastewater treatment process according to claim 7, wherein the ozone and/or adsorbent compound introduction is carried out in the biological reactor (3).

12. A wastewater treatment facility for implementing a process in accordance with claim 1, and comprising:
a biological treatment unit (10) provided with at least one biological reactor (3) arranged to carry out at least one biological oxidation step,
a wastewater inlet circuit (1) feeding the biological treatment unit with wastewater,
a circuit (9) for discharging wastewater off said biological treatment unit,
further comprising at least a first and a second device to introduce ozone and an adsorbent compound respectively, in the inlet circuit (1) or in the discharge circuit (9), or in the biological treatment unit (10), the discharge circuit (9) being at most in fluid communication with either of the first or second introduction device.

13. The wastewater treatment facility according to claim 12, wherein the first and the second introduction device are arranged to introduce ozone and an adsorbent compound respectively, in the inlet circuit (1) or in the biological treatment unit (10).

14. The wastewater treatment facility according to claim 12, wherein the first ozone introduction device is arranged upstream of the second adsorbent introduction device.

15. The wastewater treatment facility according to claim 12, wherein the biological treatment unit (10) further comprises a separator (4) downstream of the biological reactor (3), the separator being of the settler or float type, and at least either of the first or second introduction device being in communication with the separator.

16. The wastewater treatment facility according to claim 15, further comprising a circuit (6) for recirculating a fraction of the sludge from the separator (4) to the biological reactor (3), at least either of the first or the second introduction device being in communication with the recirculation circuit (6).

17. The wastewater treatment facility according to claim 12, further comprising downstream of the biological treatment unit (10), as a first or second introduction device, a contactor (8) arranged to contact water at the outlet of said unit with either the ozone, or the adsorbent compound.

18. The wastewater treatment facility according to claim 12, wherein the biological reactor (3) is a conventional activated sludge reactor or a fixed bed reactor or a sequential biological reactor.

19. The wastewater treatment facility according to claim 12, wherein the biological reactor (3) is a fluidised moving bed reactor or a membrane bioreactor.

20. The wastewater treatment facility according to claim 18, wherein either or both of the first or second ozone or adsorbent introduction device are in communication with the biological reactor.
